(19) United States
(12) Patent Application Publication
(10) Pub. No.: US 2020/0076966 A1
(43) Pub. Date: Mar. 5, 2020

(54) IMAGE FORMING APPARATUS AND NON-TRANSITORY COMPUTER READABLE MEDIUM

(71) Applicant: FUJI XEROX CO., LTD., Tokyo (JP)

(72) Inventor: Kiyoko SHIMADATE, Kanagawa (JP)

(73) Assignee: FUJI XEROX CO., LTD., Tokyo (JP)

(21) Appl. No.: 16/546,314

(22) Filed: Aug. 21, 2019

(30) Foreign Application Priority Data
Aug. 28, 2018 (JP) 2018-158862

(51) Int. Cl. H04N 1/00

(52) U.S. Cl. CPC H04N 1/00214; H04N 2201/0094; H04N 1/00408

(57) ABSTRACT

An image forming apparatus includes a display that displays an operation screen for designating a destination to use a certain function; and a display controller that, in a case where a hardware operation button that has been additionally attached is operated, performs control so that the operation screen displayed on the display shifts to an operation screen for setting a destination based on entry using the hardware operation button and so that a software operation button including an operation button corresponding to the hardware operation button and an operation button for realizing a function other than a function realized by the hardware operation button is displayed within a display screen of the display.

### CROSS-REFERENCE TO RELATED APPLICATIONS

This application is based on and claims priority under 35 USC 119 from Japanese Patent Application No. 2018-158862 filed Aug. 28, 2018.

### BACKGROUND

### (i) Technical Field

The present disclosure relates to an image forming apparatus and a non-transitory computer readable medium.

### (ii) Related Art

Japanese Unexamined Patent Application Publication No. 2017-118475 discloses an image forming apparatus that shifts an operation screen displayed on a display from a destination selection screen to a number entry screen upon detection of entry of a number on an external input device such as a hardware numeric keypad in a state where the destination selection screen for selection of a destination of FAX is being displayed on the display.

### SUMMARY

Aspects of non-limiting embodiments of the present disclosure relate to providing an image forming apparatus and a non-transitory computer readable medium that can reduce the number of operations as compared with a case where control is performed so that all software operation buttons are not displayed within an operation screen in a case where a hardware operation button is attached.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: a display that displays an operation screen for designating a destination to use a certain function; and a display controller that, in a case where a hardware operation button that has been additionally attached is operated, performs control so that the operation screen displayed on the display shifts to an operation screen for setting a destination based on entry using the hardware operation button and so that a software operation button including an operation button corresponding to the hardware operation button and an operation button for realizing a function other than a function realized by the hardware operation button is displayed within a display screen of the display.

### BRIEF DESCRIPTION OF THE DRAWINGS

An exemplary embodiment of the present disclosure will be described in detail based on the following figures, wherein:

FIG. 1 illustrates a configuration of an image forming apparatus according to an exemplary embodiment of the present disclosure;

FIG. 2 is a block diagram illustrating a hardware configuration of the image forming apparatus according to the exemplary embodiment of the present disclosure;

FIG. 3 is a block diagram illustrating a functional configuration of the image forming apparatus according to the exemplary embodiment of the present disclosure;

FIG. 4 is a view for explaining an example of an operation procedure of copying in a case where a hardware numeric keypad is not attached;

FIG. 5 is a view for explaining an example of an operation procedure of copying in a case where the hardware numeric keypad is not attached;

FIG. 6 is a view for explaining an example of an operation procedure of copying in a case where the hardware numeric keypad is not attached;

FIG. 7 is a view for explaining an example of an operation procedure of copying in a case where the hardware numeric keypad is not attached;

FIG. 8 is a view for explaining an example of an operation procedure of copying in a case where the hardware numeric keypad is attached;

FIG. 9 is a view for explaining an example of an operation procedure of copying in a case where the hardware numeric keypad is attached;

FIG. 10 is a view for explaining an example of a procedure of facsimile transmission in a case where the hardware numeric keypad is not attached;

FIG. 11 is a view for explaining an example of a procedure of facsimile transmission in a case where the hardware numeric keypad is not attached;

FIG. 12 is a view for explaining an example of a procedure of facsimile transmission in a case where the hardware numeric keypad is not attached;

FIG. 13 is a view for explaining an example of a procedure of facsimile transmission in a case where the hardware numeric keypad is not attached;

FIG. 14 is a view for explaining an example of a procedure of facsimile transmission in a case where the hardware numeric keypad is not attached;

FIG. 15 is a view for explaining how display control of a software numeric keypad for facsimile transmission and a normal software numeric keypad is performed in a case where the hardware numeric keypad is attached and in a case where the hardware numeric keypad is not attached;

FIG. 16 is a view for explaining an example of a procedure of facsimile transmission in a case where the hardware numeric keypad is attached;

FIG. 17 is a view for explaining an example of a procedure of facsimile transmission in a case where the hardware numeric keypad is attached;

FIG. 18 is a view for explaining an example of a procedure of facsimile transmission in a case where the hardware numeric keypad is attached;

FIG. 19 is a view for explaining an example of a procedure of facsimile transmission in a case where the hardware numeric keypad is attached;

FIG. 20 is a view for explaining an example of a procedure of facsimile transmission in a case where the hardware numeric keypad is attached;

FIG. 21 is a view for explaining an example of a procedure of facsimile transmission in a case where the hardware numeric keypad is attached;

FIG. 22 is a view for explaining an example of an operation procedure in a case where plural destinations are successively set; and

FIG. 23 is a view for explaining an example of an operation procedure in a case where plural destinations are successively set.

### DETAILED DESCRIPTION

Next, an exemplary embodiment of the present disclosure is described in detail with reference to the drawings.

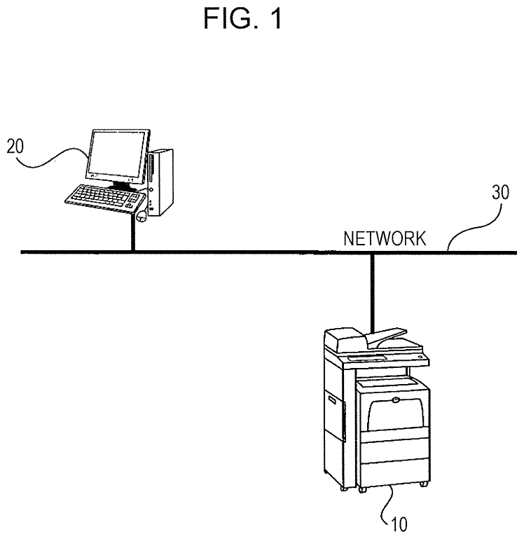

FIG. 1 illustrates a configuration of an image forming system according to the exemplary embodiment of the present disclosure.

As illustrated in FIG. 1, the image forming system according to the exemplary embodiment of the present disclosure is constituted by an image forming apparatus 10 and a terminal apparatus 20 that are connected to each other over a network 30. The terminal apparatus 20 generates print data and transmits the generated print data to the image forming apparatus 10 over the network 30. The image forming apparatus 10 receives the print data transmitted from the terminal apparatus 20 and outputs an image based on the print data on a sheet of paper. The image forming apparatus 10 is an apparatus called a multi-function printer having plural functions such as a print function, scan function, a copy function, and a facsimile function.

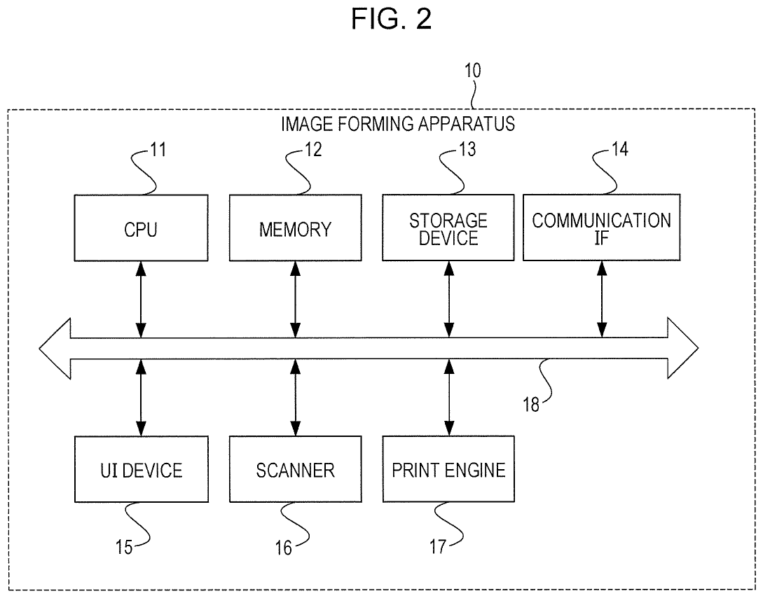

Next, FIG. 2 illustrates a hardware configuration of the image forming apparatus 10 in the image forming system according to the present exemplary embodiment.

As illustrated in FIG. 2, the image forming apparatus 10 includes a CPU 11, a memory 12, a storage device 13 such as a hard disk drive (HDD), a communication interface (IF) 14 that transmits and receives data to and from an external device or the like over the network 30, a user interface (UI) device 15 that includes a touch panel or a liquid crystal display and a keyboard, a scanner 16, and a print engine 17. These constituent elements are connected to one another through a control bus 18.

The print engine 17 prints an image on a recording medium such as a print sheet after processes such as charging, exposure, development, transfer, and fixing.

The CPU 11 controls operation of the image forming apparatus 10 by executing predetermined processing on the basis of a control program stored in the memory 12 or the storage device 13.

Although in the present exemplary embodiment, it is assumed that the CPU 11 reads out the control program stored in the memory 12 or the storage device 13 and then execute the control program, the program may be stored in a recording medium such as a CD-ROM and be supplied to the CPU 11.

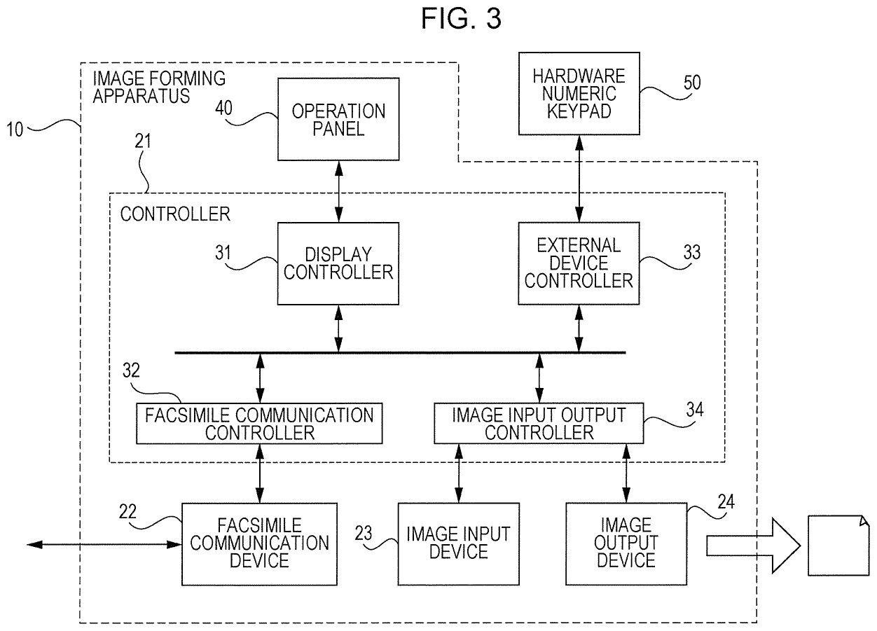

FIG. 3 is a block diagram illustrating a functional configuration of the image forming apparatus 10 realized by execution of the control program.

As illustrated in FIG. 3, the image forming apparatus 10 according to the present exemplary embodiment includes a controller 21, a facsimile communication device 22, an image input device 23, an image output device 24, and an operation panel 40. The controller 21 controls overall operation of the image forming apparatus 10 and includes a display controller 31, a facsimile communication controller 32, an external device controller 33, and an image input output controller 34.

Conventionally, such an image forming apparatus 10 is provided with a hardware numeric keypad that is hardware operation buttons provided in a panel part operated by a user, and this hardware numeric keypad is used to enter various kinds of numeric values.

However, recent image forming apparatuses often have no hardware numeric keypad for the purpose of a reduction in size or simplification of a panel part. Furthermore, recent image forming apparatuses often have a simple panel part provided with a small number of components such as buttons so that user's operability improves.

In view of the circumstances, the image forming apparatus 10 according to the present exemplary embodiment is not equipped with the hardware numeric keypad 50 as standard equipment when the image forming apparatus 10 is shipped from a factory, and the hardware numeric keypad 50 can be additionally attached to the image forming apparatus 10, for example, when needed by a user. That is, only in a case where the user desires the external hardware numeric keypad 50 as an option, the hardware numeric keypad 50 is incorporated into the image forming apparatus 10. The hardware numeric keypad 50 is hardware operation buttons (operation buttons) for entry of numerical values including keys corresponding to ten numbers (0 to 9).

In a case where the hardware numeric keypad 50 is not attached to the image forming apparatus 10, a software numeric keypad (software operation buttons) is displayed on the operation panel 40 constituted, for example, by a touch panel, and a user enters a numeric value by operating the software numeric keypad. In such a case where a software numeric keypad is displayed within an operation panel, the software numeric keypad is generally displayed only when a numeric value need be entered. This is to effectively utilize a limited display region of the operation panel.

As described above, even in a case where a hardware numeric keypad is not attached, a user can enter a numeric value by using a software numeric keypad. However, it is highly likely that a user who frequently enters a numeric value, for example, a user who often uses a facsimile transmission function desires attachment of the hardware numeric keypad 50 in order to improve operability of numeric value entry.

The image input output controller 34 performs various kinds of control such as control for outputting, from the image output device 24, an image based on a print job (print data) received, for example, from the terminal apparatus 20 and control for reading a document image by using the image input device 23. The image output device 24 outputs an image on a recording medium such as a print sheet on the basis of control of the image input output controller 34. The image input device 23 performs operation of reading an image from a placed document on the basis of control of the image input output controller 34.

The operation panel 40 is controlled by the display controller 31. On the operation panel 40, various kinds of information are displayed for a user and information on various kinds of operations performed by a user are entered. For example, the operation panel 40 functions as a display that displays an operation screen for designating a destination to use a certain function. Specifically, in a case where a facsimile transmission function is used, an operation screen for designating a destination to which an image is to be transmitted is displayed on the operation panel 40.

The facsimile communication device 22 transmits image data by facsimile, for example, through a public telephone network on the basis of control of the facsimile communication controller 32.

The facsimile communication controller 32 performs control of a facsimile function of causing the facsimile communication device 22 to transmit a document image read by the image input device 23 to a designated destination.

The external device controller 33 performs operation of detecting the presence or absence of various kinds of external devices that have been additionally attached and controls operation of the detected various kinds of external devices including the hardware numeric keypad 50.

In a case where attachment of the hardware numeric keypad 50 is detected by the external device controller 33, the display controller 31 performs control for displaying a numeric value entered by using the hardware numeric keypad 50 in a field such as a field for the number of copies or a field for entry of a destination of facsimile transmission displayed on the operation panel 40.

In the image forming apparatus 10 according to the present exemplary embodiment, in a case where the hardware numeric keypad 50 that has been additionally attached is operated while a basic operation screen for facsimile transmission is being displayed on the operation panel 40 that is a display, the display controller 31 shifts the operation screen displayed on the operation panel 40 to an operation screen for setting a destination of facsimile transmission based on entry using the hardware numeric keypad 50.

Furthermore, in a case where the operation screen for setting a destination of facsimile transmission is displayed, the display controller 31 performs control so that a software numeric keypad including an operation button corresponding to the hardware numeric keypad 50 and an operation button realizing a function other than a numeric value entering function realized by the hardware numeric keypad 50 is displayed within a display screen of the operation panel 40.

The hardware numeric keypad 50 according to the present exemplary embodiment is constituted by twelve buttons, i.e., ten buttons corresponding to numeric values 0 to 9 and a “*” button and a “#” button. Accordingly, for example, operation buttons such as an operation button for successively setting plural destinations as destinations of facsimile transmission and an operation button for selecting the type of line used for facsimile transmission correspond to the operation button for realizing a function other than the function realized by the hardware numeric keypad 50.

Note that in a case where the hardware numeric keypad 50 is not attached and where an operation screen for setting information that can be entered by using only operation buttons for numeric value entry included in the hardware numeric keypad 50, for example, an operation screen displayed for setting of the number of copies is displayed, the display controller 31 performs control so that a software numeric keypad including only the operation buttons corresponding to the hardware numeric keypad 50 is displayed within the display screen of the operation panel 40. However, in a case where the hardware numeric keypad 50 is attached, the display controller 31 performs control so that a software numeric keypad including only the operation buttons corresponding to the hardware numeric keypad 50 is not displayed within the display screen of the operation panel 40.

The software numeric keypad including only the operation buttons corresponding to the hardware numeric keypad 50 is a simple software numeric keypad constituted by twelve buttons, i.e., ten buttons corresponding to numeric values 0 to 9 and a “*” button and a “#” button as with the hardware numeric keypad 50. That is, all kinds of information that can be entered by using such a simple software numeric keypad can be entered by using the hardware numeric keypad 50, and therefore it is better not to display the software numeric keypad because the display region of the operation panel 40 can be effectively used.

Next, operation of the image forming apparatus 10 according to the present exemplary embodiment is described in detail with reference to the drawings.

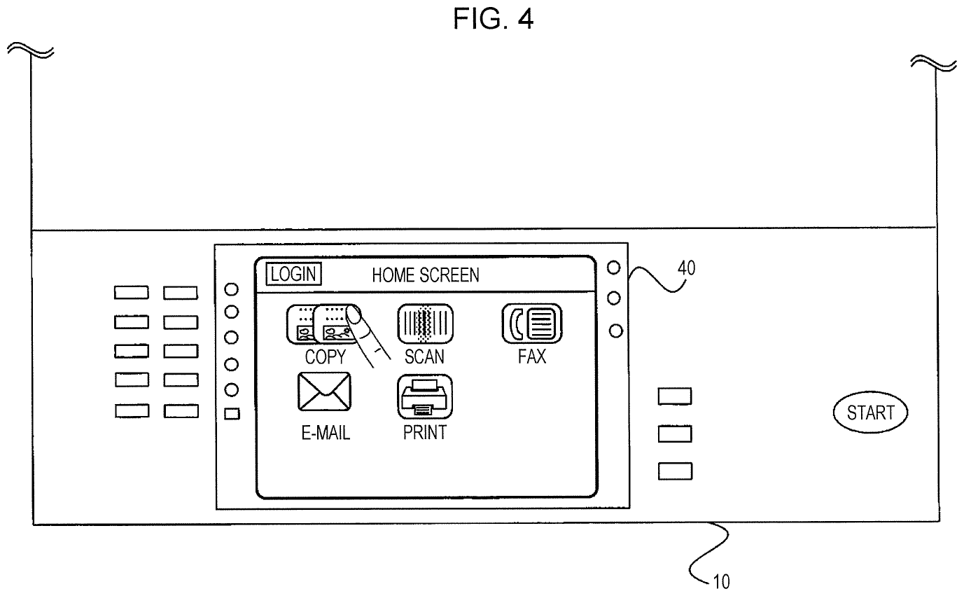

First, an example of an operation procedure of copying in a case where the hardware numeric keypad 50 is not attached is described with reference to FIGS. 4 through 7.

FIG. 4 illustrates a case where a user who tries to execute copy processing by using the image forming apparatus 10 to which the hardware numeric keypad 50 is not attached selects an icon for selecting a copy function on a home screen displayed on the operation panel 40.

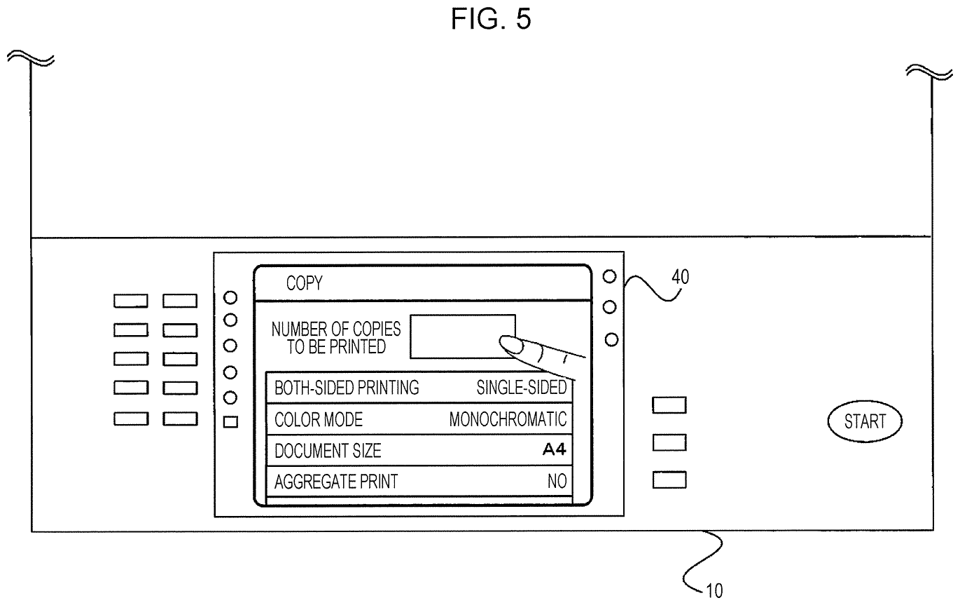

When the user selects the icon for selecting the copy function, the operation screen shifts to a screen for various kinds of settings of copy processing like the one illustrated in FIG. 5. In the example of the operation screen illustrated in FIG. 5, the user selects an entry field for the number of copies to be printed.

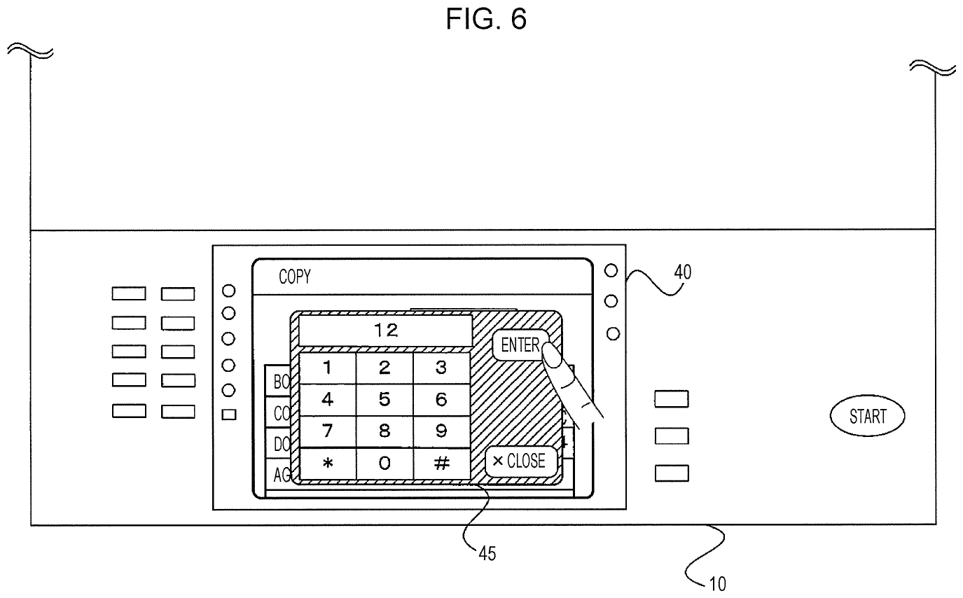

When the user selects the entry field for the number of copies to be printed, the operation screen shifts to a screen like the one illustrated in FIG. 6. On the operation screen illustrated in FIG. 6, a software numeric keypad 45 for setting the number of copies is displayed within the operation screen displayed on the operation panel 40.

The user can set the number of copies to be printed by operating the software numeric keypad 45 as illustrated in FIG. 6. In the example of the operation screen illustrated in FIG. 6, the user enters a value “12” and then operates an enter button.

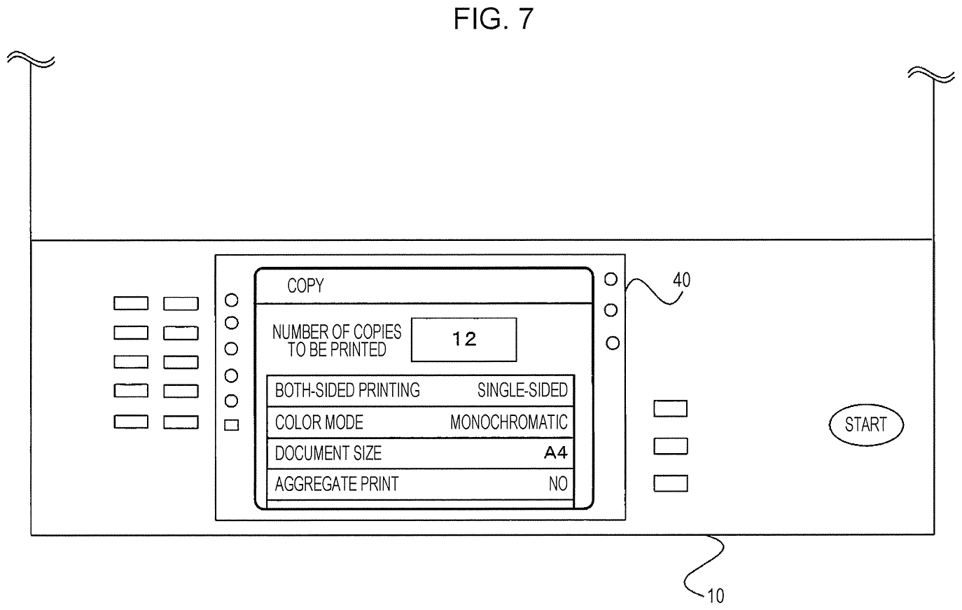

When the user sets the number of copies to be printed by operating the software numeric keypad 45 as described above, the operation screen is displayed in a state where the value “12” has been entered in the entry field for the number of copies to be printed as illustrated in FIG. 7. Then, when the user operates a start button, copy processing is executed.

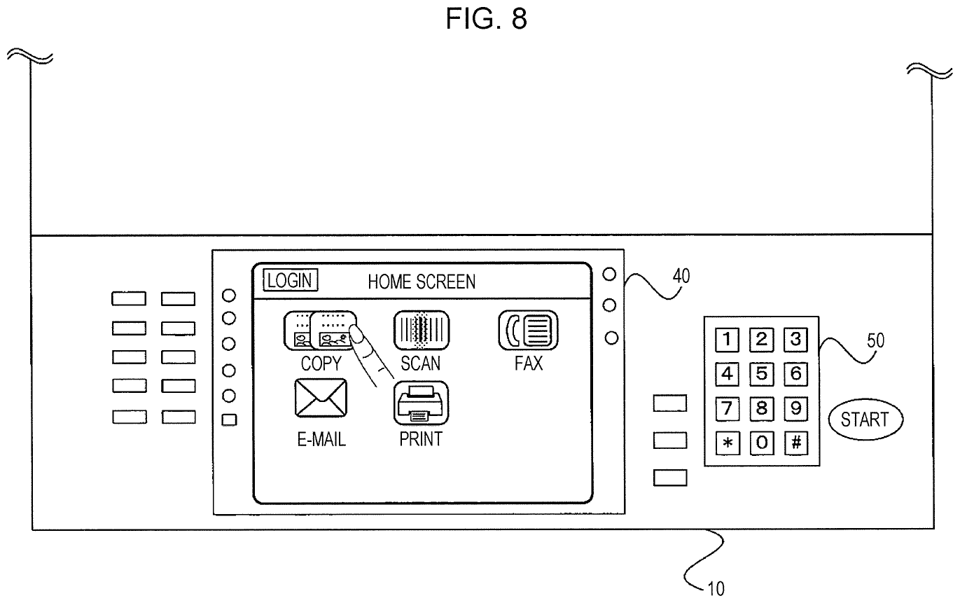

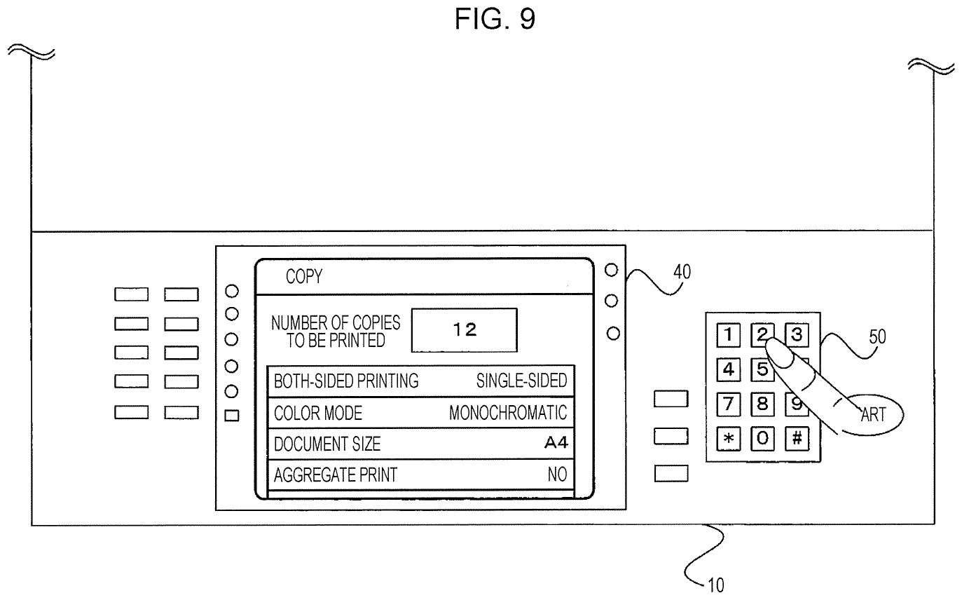

Next, an example of an operation procedure of copying in a case where the hardware numeric keypad 50 is attached is described with reference to FIGS. 8 and 9.

The hardware numeric keypad 50 that is an optional part is attached to the panel part of the image forming apparatus 10 illustrated in FIG. 8. The following describes a case where a user who tries to execute copy processing by using the image forming apparatus 10 to which the hardware numeric keypad 50 has been attached as described above selects an icon for selecting a copy function on a home screen displayed on the operation panel 40.

When the user selects the icon for selecting the copy function in such a state, the operation screen shifts to a screen for various kinds of settings of copy processing like the one illustrated in FIG. 9. However, in the example of the operation screen illustrated in FIG. 9, the software numeric keypad 45 like the one illustrated in FIG. 6 is not displayed within the operation screen even in a case where the entry field for the number of copies to be printed is selected by the user. In the example of the operation screen illustrated in FIG. 9, the software numeric keypad 45 is not displayed, and instead a value entered by using the hardware numeric keypad 50 is entered and displayed in the entry field for the number of copies to be printed.

In a case where the hardware numeric keypad 50 is attached and where an operation screen just for entry of a numeric value such as an operation screen for setting of the number of copies to be printed is displayed, the user can enter a desired numeric value without any inconvenience even in a case where the software numeric keypad 45 constituted by operation buttons almost exclusive for numeric value entry is not displayed.

Conversely, not displaying the software numeric keypad 45 makes it possible to display other kinds of information on the operation screen within the operation panel 40, thereby making it possible to effectively use the display region.

However, in a case where the hardware numeric keypad 50 is attached and all keys of a software numeric keypad are not displayed, the number of operations needed for user's desired settings sometimes increases inconveniently for the user.

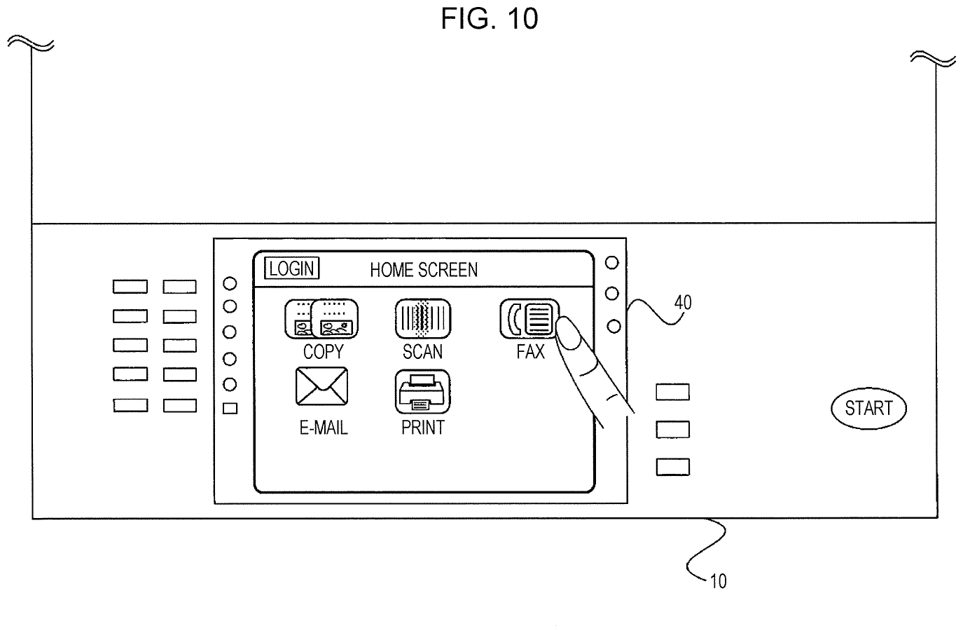

A case where a destination of facsimile transmission is set is described as an example of such a case with reference to FIGS. 10 through 14. FIGS. 10 through 14 are views for explaining an example of a procedure of facsimile transmission in a case where the hardware numeric keypad 50 is not attached.

FIG. 10 illustrates a case where a user who tries to transmit facsimile by using the image forming apparatus 10 to which the hardware numeric keypad 50 is not attached selects an icon for selecting a facsimile function on a home screen displayed on the operation panel 40.

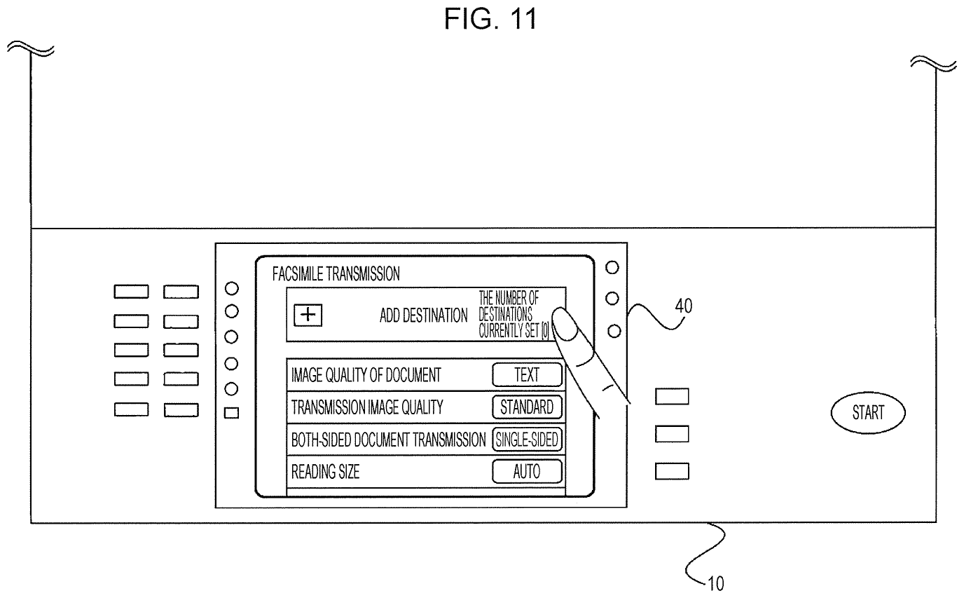

When the user selects the icon for selecting the facsimile function as described above, the operation screen shifts to a screen for various kinds of settings for facsimile transmission like the one illustrated in FIG. 11. A case where the user selects an operation button for adding a destination of facsimile transmission as in the example of the operation screen illustrated in FIG. 11 is described.

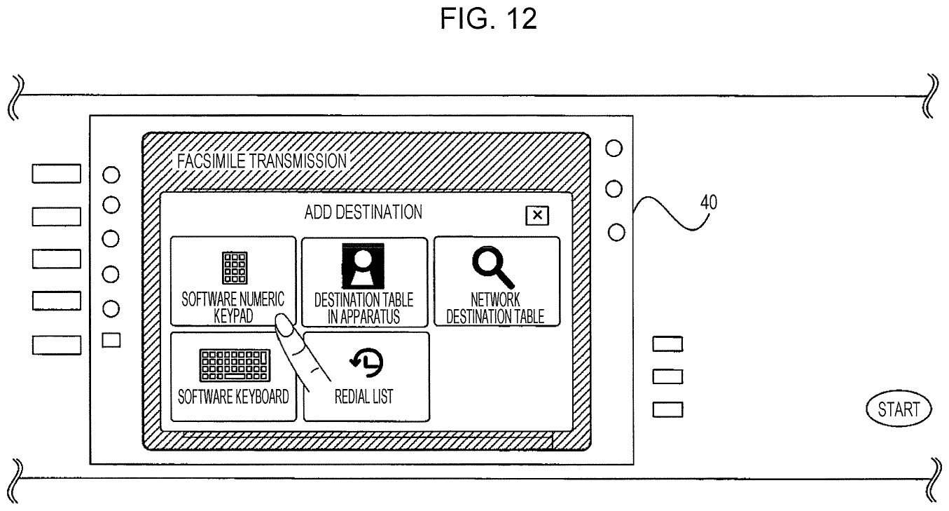

When the user selects the operation button for adding a destination, the operation screen shifts to a screen like the one illustrated in FIG. 12. On the operation screen illustrated in FIG. 12, various kinds of buttons for selecting types of operations methods for entry of a destination are displayed.

On the operation screen illustrated in FIG. 12, a “software numeric keypad” button is a button for selecting a method for setting a destination while displaying a software numeric keypad within the operation screen. A “software keyboard” is a button for selecting a method for setting, for example, a destination using alphabets such as an e-mail address while displaying a software keyboard constituted by various kinds of buttons such as numbers and alphabets.

Furthermore, a “destination table in apparatus” button and a “network destination table” button are buttons for selecting a method for setting a destination of facsimile transmission while displaying a destination table stored in the image forming apparatus 10 or displaying a destination table stored in another apparatus through a network.

Furthermore, a “redial list” is a button for selecting a method for displaying a past transmission history and setting a destination used in the past again.

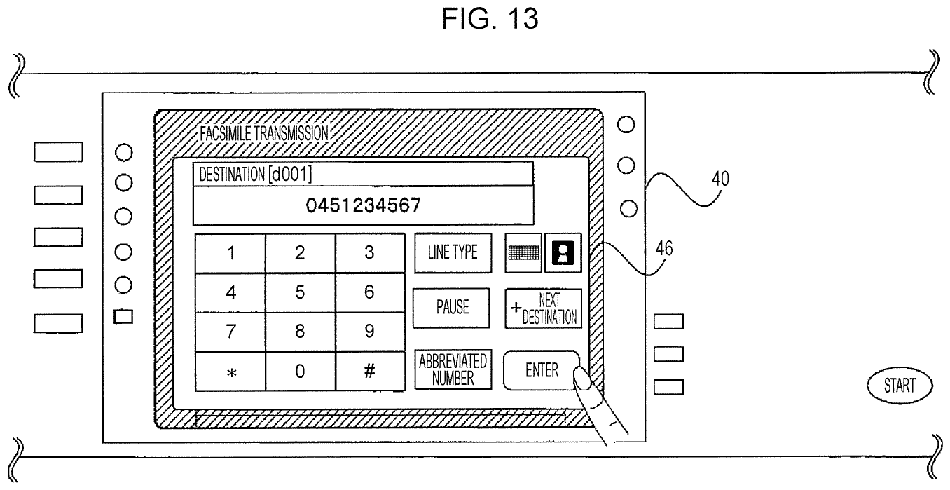

In a case where the user selects the “software numeric keypad” button on the operation screen illustrated in FIG. 12, an operation screen like the one illustrated in FIG. 13 is displayed on the display panel 40.

On the operation screen illustrated in FIG. 13, a software numeric keypad 46 for facsimile transmission is displayed within the display panel 40. The software numeric keypad 46 for facsimile transmission includes various kinds of operation buttons for setting a destination of facsimile transmission, unlike the normal software numeric keypad 45 illustrated in FIG. 6, which is a simple software numeric keypad.

Specifically, the software numeric keypad 46 for facsimile transmission includes buttons such as a “line type” button, a “pause” button, an “abbreviated number” button, and a “next destination” button in addition to the operation buttons corresponding to 0 to 9 for entry of numeric values. Note that the software numeric keypad 46 for facsimile transmission also includes an operation button for displaying a software keyboard, an operation button for displaying a destination table (address table), and the like.

The “line type” button is an operation button for selecting the type of line used for facsimile transmission such as a public telephone line or an Internet line.

The “pause” button is an operation button used to set a waiting period, for example, in a case where “0” is entered for connection to an external line through a telephone switchboard and a next number is entered after elapse of a certain period from the entry of “0”.

The “abbreviated number” button is an operation button used to set a destination by entering a simple numeric value in a case where destination information is registered in association with a simple number in advance.

The “next destination” button is an operation button for successively setting plural destinations. By sequentially setting a destination by using the “next destination” button, plural destinations can be sequentially set without performing an operation of returning, to the setting screen for facsimile transmission every time a single destination is set.

Since the software numeric keypad 46 for facsimile transmission is provided with various kinds of operation buttons having a function other than a numeric value entering function, it is inconvenient for a user if the software numeric keypad 46 for facsimile transmission is hidden by attachment of the hardware numeric keypad 50.

Accordingly, in the image forming apparatus 10 according to the present exemplary embodiment, the display controller 31 controls the operation panel 40 so that the software numeric keypad 46 for facsimile transmission is displayed even in a case where the hardware numeric keypad 50 is attached.

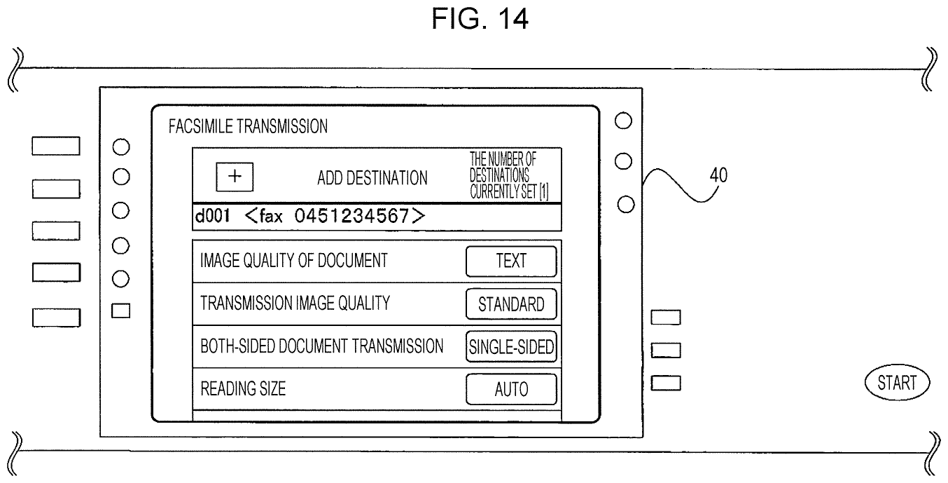

When the user enters a destination by operating the software numeric keypad 46 for facsimile transmission and then operates an enter button on the operation screen illustrated in FIG. 13, the entered destination “0451234567” is set as a destination of facsimile transmission as illustrated in FIG. 14.

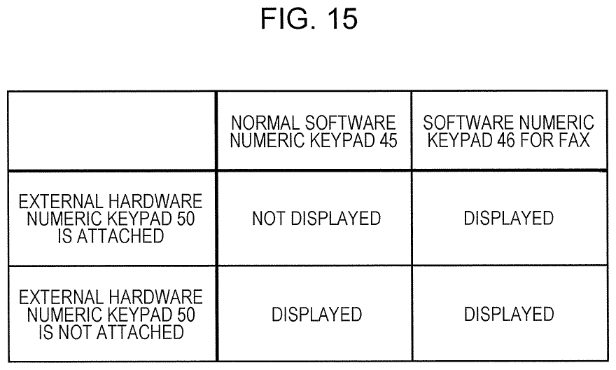

FIG. 15 illustrates how display control of the software numeric keypad 46 for facsimile transmission (software numeric keypad for FAX) and the normal software numeric keypad 45 is performed in a case where the hardware numeric keypad 50 is attached and in a case where the hardware numeric keypad 50 is not attached.

As illustrated in FIG. 15, the normal software numeric keypad 45 almost exclusive for entry of a numeric value is not displayed in a case where the external hardware numeric keypad 50 is attached and is displayed in a case where the external hardware numeric keypad 50 is not attached.

As illustrated in FIG. 15, the software numeric keypad 46 for facsimile transmission including operation buttons for various functions convenient for facsimile transmission other than the numeric value entering function is displayed as a matter of course in a case where the external hardware numeric keypad 50 is not attached and is displayed even in a case where the external hardware numeric keypad 50 is attached.

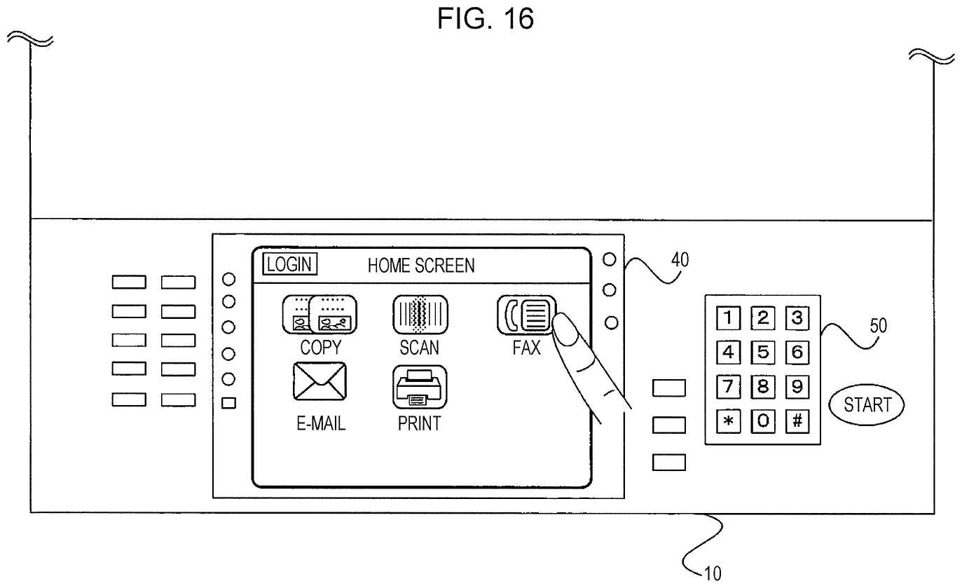

Next, an example of a procedure of facsimile transmission in a case where the hardware numeric keypad 50 is attached is described with reference to FIGS. 16 through 21.

FIG. 16 illustrates a case where a user who tries to transmit facsimile by using the image forming apparatus 10 to which the hardware numeric keypad 50 has been attached selects an icon for selecting a facsimile function on a home screen displayed on the operation panel 40.

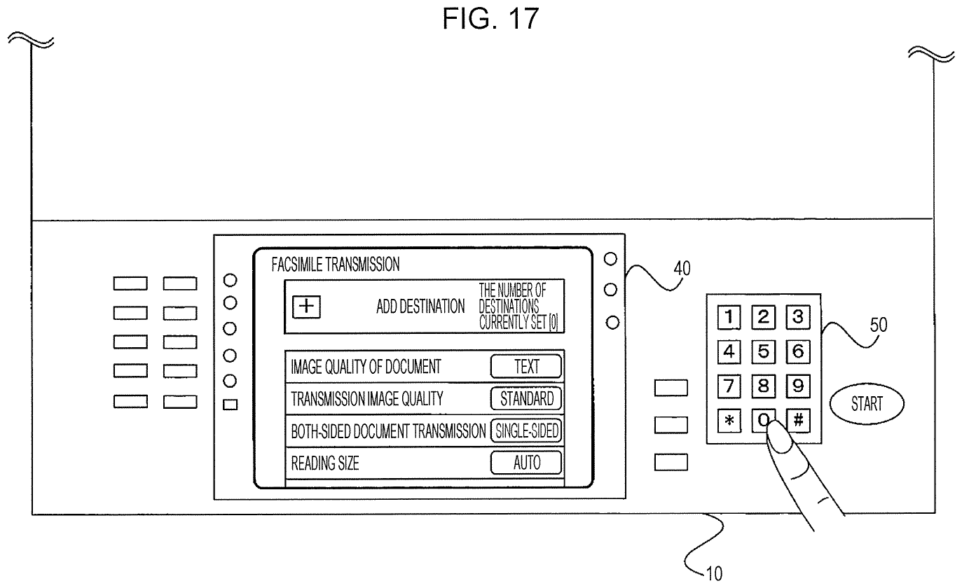

When the user selects the icon for selecting the facsimile function as described above, the operation screen shifts to a screen for various settings of facsimile transmission as illustrated in FIG. 17. The following describes a case where the user operates a “0” button of the hardware numeric keypad 50 while a basic operation screen for facsimile transmission is being displayed as illustrated in FIG. 17.

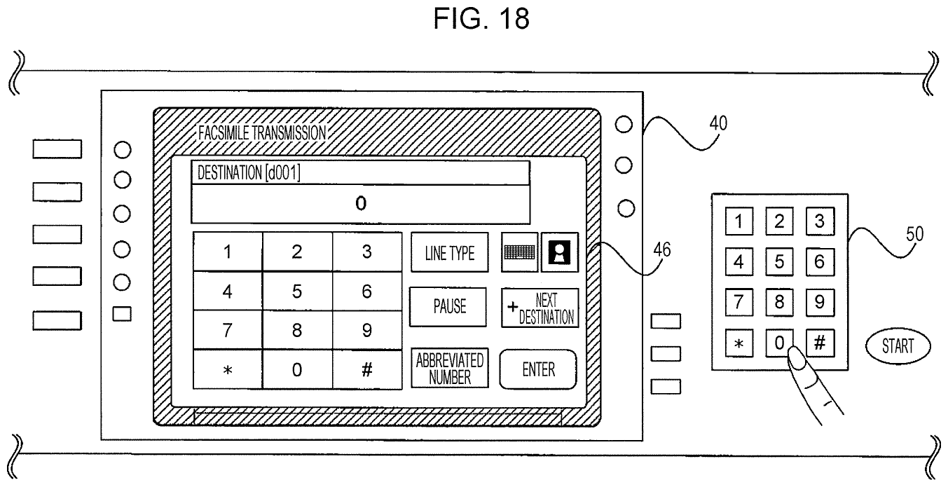

In a case where the hardware numeric keypad 50 that has been additionally attached is operated by the user as illustrated in FIG. 17, the operation screen displayed on the operation panel 40 shifts to an operation screen for setting a destination based on entry using the hardware numeric keypad 50 like the one illustrated in FIG. 18. Specifically, in FIG. 18, the software numeric keypad 46 for facsimile transmission is displayed on the operation screen, and destination information entered by user's operation of the hardware numeric keypad 50 is entered in an entry field of the software numeric keypad 46 for facsimile transmission.

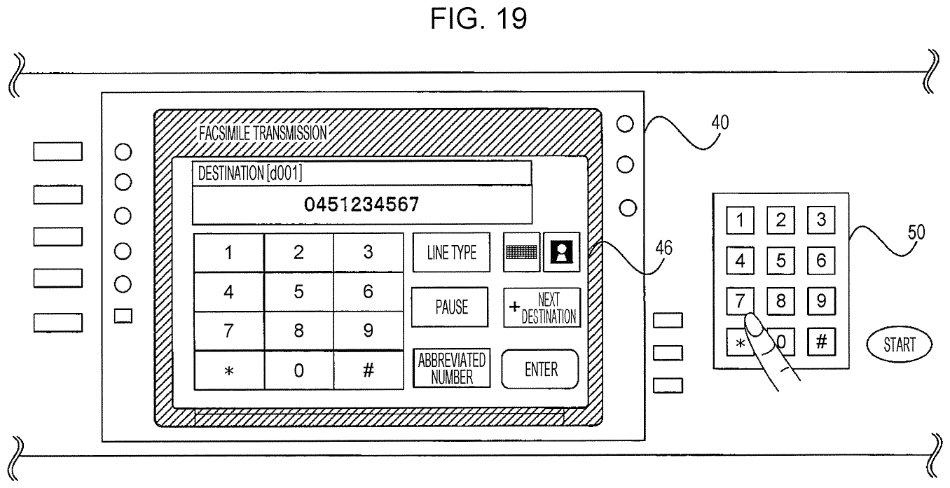

The following describes a case where the user enters information “0451234567” by operating the hardware numeric keypad 50 as illustrated in FIG. 19.

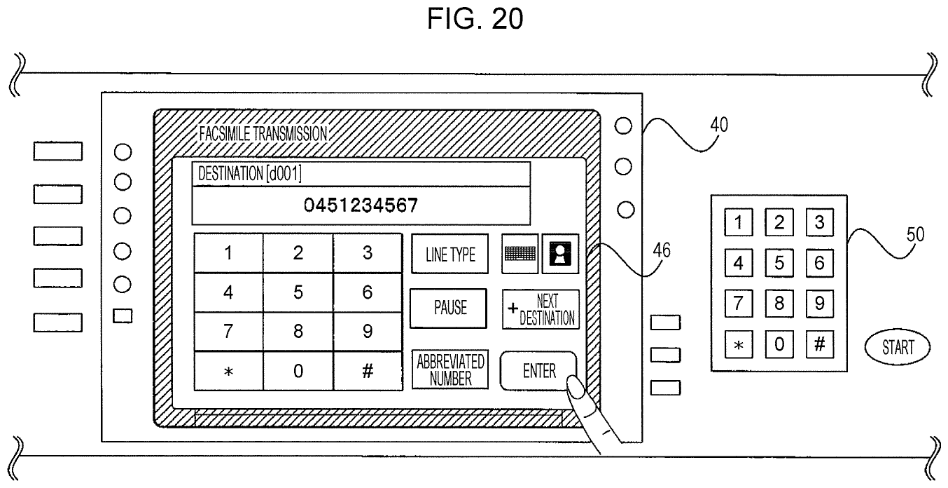

When the user operates the enter button of the software numeric keypad 46 for facsimile transmission after entering the information “0451234567” as illustrated in FIG. 20, the entered destination is set as a destination of facsimile transmission.

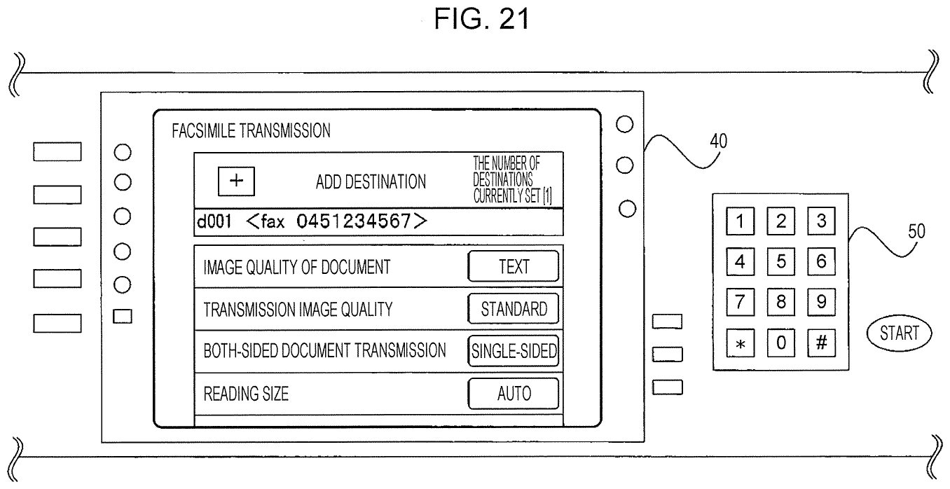

FIG. 21 illustrates the operation screen displayed after the destination “0451234567” is set. FIG. 21 illustrates a state where the entered destination is being set on the basic screen for facsimile transmission.

In the image forming apparatus 10 according to the present exemplary embodiment, by using the hardware numeric keypad 50 in a case where the hardware numeric keypad 50 is attached, the number of operations needed to set the destination “0451234567” as a destination of facsimile transmission starting from the home screen is twelve steps as described below. That is, only two steps are needed to set a destination excluding ten steps for entering the destination information (0451234567).

(1) Select the icon for selecting a facsimile function on the home screen (FIG. 16)

(2) Operate a “0” button of the hardware numeric keypad 50 (FIGS. 17 and 18)

(3) to (11) Enter “451234567” by operating the hardware numeric keypad 50 (FIG. 19)

(12) Operate the enter button of the software numeric keypad 46 for facsimile transmission (FIG. 20)

Meanwhile, in a case where the hardware numeric keypad 50 is not attached, the number of operations needed to set the destination “0451234567” as a destination of facsimile transmission starting from the home screen is fourteen steps as described below. That is, four steps are needed to set a destination excluding ten steps for entering the destination information (0451234567).

(1) Select the icon for selecting a facsimile function on the home screen (FIG. 10)

(2) Operate the destination adding button (FIG. 11)

(3) Operate the “software numeric keypad” button (FIG. 12)

(4) to (13) Enter “0451234567” by operating the software numeric keypad 46 for facsimile transmission (FIG. 13)

(14) Operate the enter button of the software numeric keypad 46 for facsimile transmission (FIG. 13)

That is, in the present exemplary embodiment, in a case where the hardware numeric keypad 50 is attached, the basic screen for setting a facsimile function shifts to a screen for displaying the software numeric keypad 46 for facsimile transmission when any of the operation buttons of the hardware numeric keypad 50 is operated. As a result, the operation of the destination adding button illustrated in FIG. 11 and the operation of selecting the type of operation method for entry of a destination illustrated in FIG. 12 become unnecessary, and therefore a destination can be set with a smaller number of operation steps.

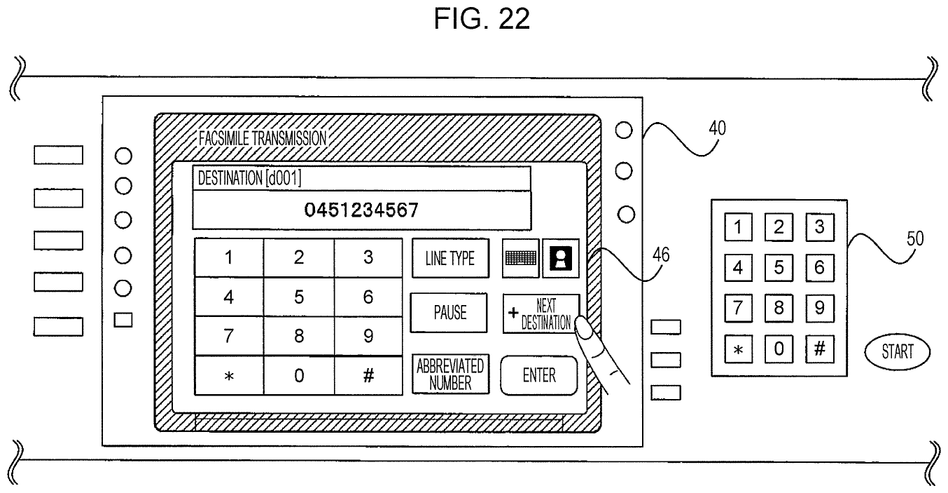

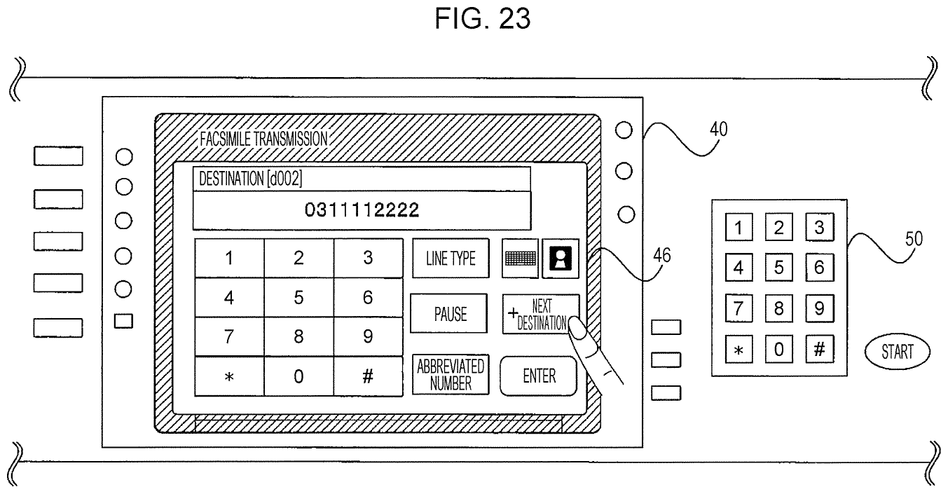

Displaying the software numeric keypad 46 for facsimile transmission even in a case where the hardware numeric keypad 50 is attached makes the number of operations small. Finally, this is described with reference to FIGS. 22 and 23.

FIGS. 22 and 23 are views for explaining an example of an operation procedure in a case where plural destinations are successively set.

For example, in a case where the user operates the “next destination” button after entering the destination information “0451234567” as illustrated in FIG. 22, this destination information is set as a destination, and the software numeric keypad 46 for facsimile transmission remains to be displayed within the operation panel 40.

Accordingly, in a case where the user enters next destination information “0311112222” and then further sets a next destination as illustrated in FIG. 23, a destination can be successively set by a similar operation by operating the “next destination” button.

That is, use of the software numeric keypad 46 for facsimile transmission including an operation button, such as the “next destination” button, having a function for setting a destination of facsimile transmission makes it possible to set a destination with a smaller number of operation steps than in a case where the software numeric keypad 46 for facsimile transmission is not displayed.

In a case where the hardware numeric keypad 50 is attached and where any of the operation buttons of the hardware numeric keypad 50 is operated on the basic screen for facsimile transmission, the software numeric keypad 46 for facsimile transmission is displayed so that an entering operation can be performed by using both of the hardware numeric keypad 50 and the software numeric keypad 46 for facsimile transmission. This improves operability of user's setting of a destination of facsimile transmission.

### Modification

Although a case where the hardware numeric keypad 50 for entry of a numeric value is used as an example of a hardware operation button that can be attached additionally as an option has been described in the above exemplary embodiment, the present disclosure is not limited to such a case. The present disclosure is also applicable to a case where an optional operation button constituted by a hardware component other than the hardware numeric keypad 50 is used.

Although a case where an operation for setting a destination of facsimile transmission is performed has been described in the above exemplary embodiment, the present disclosure is not limited to such a case. The present disclosure is also applicable to a case where some sort of destination is set.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
a display that displays an operation screen for designating a destination to use a certain function; and
a display controller that, in a case where a hardware operation button that has been additionally attached is operated, performs control so that the operation screen displayed on the display shifts to an operation screen for setting a destination based on entry using the hardware operation button and so that a software operation button including an operation button corresponding to the hardware operation button and an operation button for realizing a function other than a function realized by the hardware operation button is displayed within a display screen of the display.

2. The image forming apparatus according to claim 1, wherein
the operation button for realizing the function other than the function realized by the hardware operation button is an operation button for successively setting plural destinations.

3. The image forming apparatus according to claim 1, wherein
in a case where an operation screen for setting information whose entry is possible by only an operation button included in the hardware operation button is displayed, the display controller performs control so that a software operation button including only the operation button corresponding to the hardware operation button is displayed within the display screen of the display in a case where the hardware operation button is not attached and performs control so that the software operation button including only the operation button corresponding to the hardware operation button is not displayed within the display screen of the display in a case where the hardware operation button is attached.

4. The image forming apparatus according to claim 2, wherein
in a case where an operation screen for setting information whose entry is possible by only an operation button included in the hardware operation button is displayed, the display controller performs control so that a software operation button including only the operation button corresponding to the hardware operation button is displayed within the display screen of the display in a case where the hardware operation button is not attached and performs control so that the software operation button including only the operation button corresponding to the hardware operation button is not displayed within the display screen of the display in a case where the hardware operation button is attached.

5. The image forming apparatus according to claim 1, wherein
the hardware operation button is an operation button for entry of a numeric value.

6. The image forming apparatus according to claim 2, wherein
the hardware operation button is an operation button for entry of a numeric value.

7. The image forming apparatus according to claim 3, wherein
the hardware operation button is an operation button for entry of a numeric value.

8. The image forming apparatus according to claim 4, wherein
the hardware operation button is an operation button for entry of a numeric value.

9. The image forming apparatus according to claim 1, wherein
the operation screen on which the software operation button is displayed is an operation screen for setting a destination of facsimile transmission.

10. The image forming apparatus according to claim 2, wherein
the operation screen on which the software operation button is displayed is an operation screen for setting a destination of facsimile transmission.

11. The image forming apparatus according to claim 3, wherein
the operation screen on which the software operation button is displayed is an operation screen for setting a destination of facsimile transmission.

12. The image forming apparatus according to claim 4, wherein
the operation screen on which the software operation button is displayed is an operation screen for setting a destination of facsimile transmission.

13. The image forming apparatus according to claim 5, wherein
the operation screen on which the software operation button is displayed is an operation screen for setting a destination of facsimile transmission.

14. The image forming apparatus according to claim 6, wherein
the operation screen on which the software operation button is displayed is an operation screen for setting a destination of facsimile transmission.

15. The image forming apparatus according to claim 7, wherein
the operation screen on which the software operation button is displayed is an operation screen for setting a destination of facsimile transmission.

16. The image forming apparatus according to claim 8, wherein
the operation screen on which the software operation button is displayed is an operation screen for setting a destination of facsimile transmission.

17. The image forming apparatus according to claim 9, wherein
the operation button for realizing the function other than the function realized by the hardware operation button is an operation button for selecting a type of line used for facsimile transmission.

18. A non-transitory computer readable medium storing a program causing a computer to execute a process, the process comprising:
displaying, on a display, an operation screen for designating a destination to use a certain function;
in a case where a hardware operation button that has been additionally attached is operated, shifting the operation screen displayed on the display to an operation screen for setting a destination based on entry using the hardware operation button: and
displaying, within a display screen of the display, a software operation button including an operation button corresponding to the hardware operation button and an operation button for realizing a function other than a function realized by the hardware operation button.

19. An image forming apparatus comprising:
display means for displaying an operation screen for designating a destination to use a certain function; and
display controlling means for, in a case where a hardware operation button that has been additionally attached is operated, performing control so that the operation screen displayed on the display means shifts to an operation screen for setting a destination based on entry using the hardware operation button and so that a software operation button including an operation button corresponding to the hardware operation button and an operation button for realizing a function other than a function realized by the hardware operation button is displayed within a display screen of the display means.
